(19) United States
(12) Patent Application Publication
(10) Pub. No.: US 2008/0084942 A1
(43) Pub. Date: Apr. 10, 2008

(54) METHOD AND APPARATUS FOR ADVANCED ADAPTIVE TWO DIMENSIONAL CHANNEL INTERPOLATION IN ORTHOGONAL FREQUENCY DIVISION MULTIPLEXING (OFDM) WIRELESS COMMUNICATION SYSTEMS

(75) Inventor: Seyed M. Hosseinian, E. Northport, NY (US)

Correspondence Address: VOLPE AND KOENIG, P.C.;DEPT. ICC, UNITED PLAZA, SUITE 1600, 30 SOUTH 17TH STREET, PHILADELPHIA, PA, 19103, US

(73) Assignee: INTERDIGITAL TECHNOLOGY CORPORATION, Wilmington, DE (US)

(21) Appl. No.: 11/867,105

(22) Filed: Oct. 4, 2007

Related U.S. Application Data
(60) Provisional application No. 60/828,113, filed on Oct. 4, 2006.

(51) Int. Cl. H04L 27/28

(52) U.S. Cl. 375/260

(57) ABSTRACT

An adaptive channel interpolation method and apparatus for OFDM wireless communication systems that use reference symbol-assisted channel estimation is disclosed. A time frequency representation of a subframe having reference symbols scattered throughout is divided into parallelograms, wherein the vertices of each parallelogram are the reference symbols. The channel response of a data symbol at the center point of the parallelogram is estimated using two of the vertices from opposing vertices of the parallelogram.

### CROSS REFERENCE TO RELATED APPLICATION

This application claims the benefit of U.S. Provisional Application No. 60/828,113, Filed on Oct. 4, 2006, which is incorporated by reference as if fully set forth.

### FIELD OF INVENTION

The present invention generally relates to wireless communication systems.

### BACKGROUND

Orthogonal frequency division multiplexing (OFDM) is a data transmission scheme where the data is split into smaller streams and each stream is transmitted using a sub-carrier with a smaller bandwidth than the total available transmission bandwidth. The efficiency of OFDM is a result of the fact that the sub-carriers are selected so that they are orthogonal to each other. In other words, the sub-carriers do not interfere with each other while each is carrying a portion of the total user data.

There are practical reasons why OFDM may be preferred over other transmission schemes such as Code Division Multiple Access (CDMA). When the user data is split into streams carried by different sub-carriers, the effective data rate on each sub-carrier is less than the total data rate. Therefore, the symbol duration is much larger. Large symbol duration can tolerate larger delay spreads. In other words, data that is transmitted with a large symbol duration is not affected by multipath as severely as symbols with a shorter duration. OFDM symbols can tolerate delay spreads that are typical in wireless communications and do not require complicated receiver designs to recover from multipath delay.

When an OFDM receiver receives a signal, it is corrected to compensate for channel degradation by determining the channel response, the variation in phase and amplitude resulting from propagation across an OFDM channel. The determination of the channel response is known as channel estimation.

In OFDM systems, efficient channel estimation is paramount for coherent detection and decoding. A dynamic estimation of the channel is necessary before the demodulation of OFDM signals since the radio channel is frequency selective and time-varying for wide-band mobile communications systems. The purpose of channel estimation is to estimate the complex value channel attenuation at all subcarriers.

A WTRU performs channel estimation of a received downlink signal to estimate the complex value channel attenuation of all subcarriers. For reference symbol assisted systems, such as a pilot symbol, a channel estimator estimates a channel at the reference symbol subcarriers. The channel is then estimated on other subcarriers using interpolation, and if necessary, extrapolation. This overall process is referred to as channel interpolation.

A basic OFDM reference symbol structure is illustrated in FIG. 1. As shown, reference symbols 41, are scattered in the OFDM symbols 40. The conventional way to conduct channel interpolation using this symbol structure consists of two steps:
1) The first step is to apply interpolation in frequency direction for those OFDM symbols that carry reference symbols 41. The interpolation algorithm could be piecewise-linear, n^{th} order Lagrange, spline, or the like.
2) The second stage is to interpolate in the time direction. The interpolation is performed per subcarrier 40. As such, any classic interpolation algorithm may be used.

However, the higher the order of the interpolation the longer the latency of channel interpolation.

Channel interpolation algorithms, though, perform poorly when used in a high speed wireless transmit/receive unit (WTRU), and also for channels with high frequency selectivity properties. Poor channel interpolation leads to degradation in block error rate (BER) performance.

There are algorithms that are purely designed for two dimensional interpolation, most of which assume data points are on a Cartesian mesh. However, algorithms that do not use a Cartesian mesh are very complicated and tedious.

Therefore, an improved method and apparatus for performing channel estimation, is desired.

### SUMMARY

An adaptive channel interpolation method and apparatus for OFDM wireless communication systems that use reference symbol-assisted channel estimation are disclosed. A time frequency representation of a subframe having reference symbols scattered throughout is divided into parallelograms, wherein the vertices of each parallelogram are the reference symbols. The channel response of a data symbol at the center point of the parallelogram is estimated using two of the vertices from opposing vertices of the parallelogram.

### BRIEF DESCRIPTION OF THE DRAWINGS

A more detailed understanding of the disclosed method and apparatus may be had from the following description of an embodiment, given by way of example and to be understood in conjunction with the accompanying drawings wherein:

FIG. 1 is an illustration of a basic reference symbol structure where reference symbols are scattered in OFDM symbols;

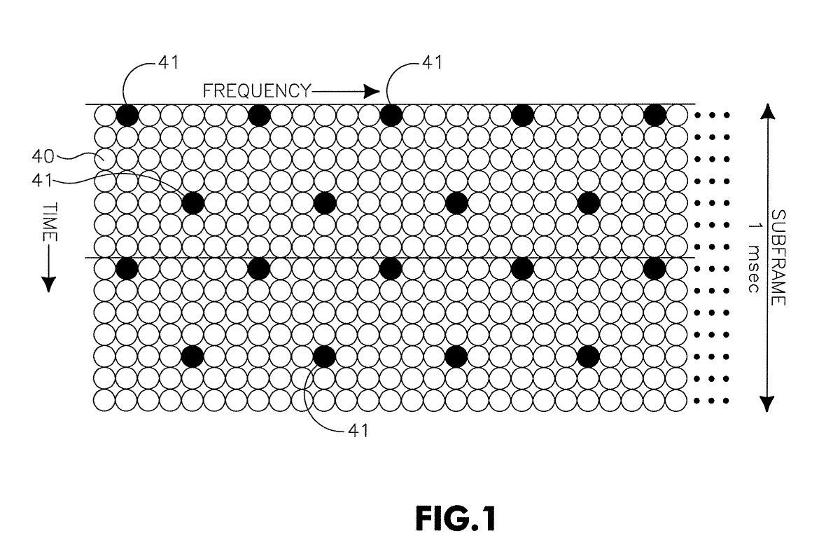

FIG. 2 is a functional block diagram of a Wireless Transmit Receive Unit (WTRU) in accordance with the present invention;

FIG. 3 is an illustration of the reference symbol structure for the E-UTRA downlink where reference symbols are re-organized as a set of non-overlapping parallelogram each with a center point subcarrier;

FIG. 4 is an illustration of the reference symbol structure of FIG. 2 where each parallelogram is examined in both frequency and time directions;

FIG. 5 is a graph of simulation results comparing adaptive two-dimensional channel interpolation in accordance with the present teachings to conventional channel interpolation techniques; and

FIG. 6 is a flow diagram of the disclosed method for adaptive two-dimensional channel interpolation.

### DETAILED DESCRIPTION

When referred to hereafter, the terminology “wireless transmit/receive unit (WTRU)” includes but is not limited to a user equipment (UE), a mobile station, a fixed or mobile subscriber unit, a pager, a cellular telephone, a personal digital assistant (PDA), a computer, or any other type of user device capable of operating in a wireless environment. When referred to hereafter, the terminology “base station” includes but is not limited to a Node-B, a site controller, an access point (AP), or any other type of interfacing device capable of operating in a wireless environment.

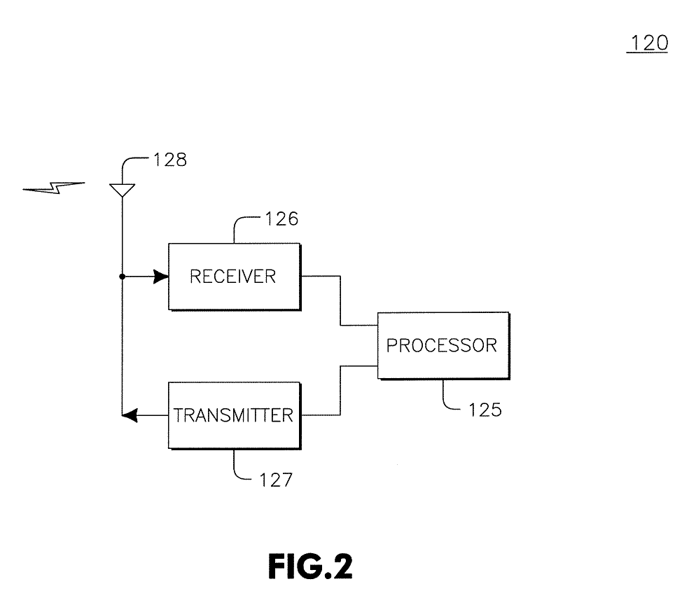

FIG. 2 is a functional block diagram of a transceiver 120 configured to perform channel estimation in a wireless system. In addition to components included in a typical transceiver, transceiver 120 includes a processor 125, comprising an estimator (not shown), configured to perform the method of channel estimation as disclosed, receiver 126 in communication with processor 125, transmitter 127 in communication with processor 125, and antenna 128 in communication with receiver 126 and transmitter 127 to facilitate the transmission and reception of wireless data. Transceiver 120 is preferably a WTRU. Wireless data is transmitted and received over an orthogonal frequency division multiplexing (OFDM) wireless communication system as will be described hereinafter.

An advanced adaptive channel interpolation method is disclosed for channel estimation in an OFDM wireless communication system. In such systems, reference symbols are scattered across OFDM symbols within a subframe, whereby, reference symbols are multiplexed with data symbols both in frequency and time. Accordingly, some OFDM symbols may contain reference symbols and some may not.

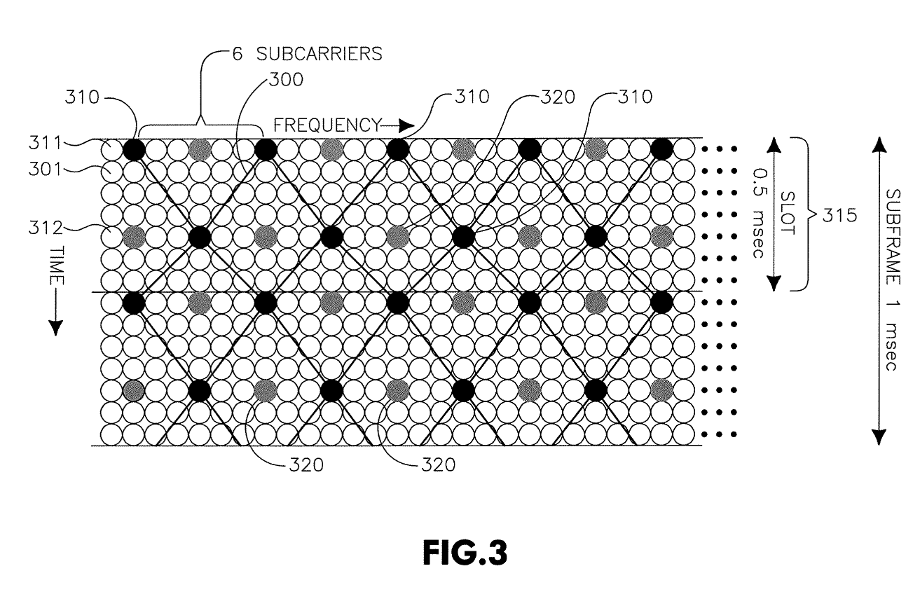

An example of the reference symbol structure proposed for evolved universal terrestrial radio access (E-UTRA) is illustrated in FIG. 3. As illustrated in this example, the first row 311 and the third to last row 312 of the OFDM symbols of slot 315 contain reference symbols 310. It should be noted that these structures are disclosed for illustrative purposes only, and are not meant to limit the scope of the present teachings. The channel is estimated by a WTRU using any conventional channel estimation technique for those subcarriers that carry reference symbols. However, channel interpolation may be performed to estimate a channel for those subcarriers that do not carry any reference symbols.

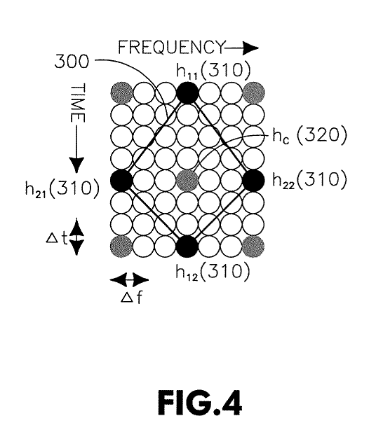

Referring to FIGS. 3 and 4, in the disclosed adaptive two dimensional interpolation method, the time-frequency plane representation of subcarriers 301 is divided into parallelograms 300, having a center point 320 (h_{c}), whose vertices are reference symbols 310, h₂₁ and h₂₂ in the frequency direction and h₁₁ and h₁₂in the time direction. Δf is the difference between adjacent subcarriers in the frequency direction; and Δt is the difference between adjacent subcarriers in the time direction. As illustrated in the example subframe in FIGS. 3 and 4, the vertices in the frequency direction h₂₁, h₂₂ are separated by 6 data symbols, including the vertice (denoted as Δx₂₁₋₂₂, not shown), and the vertices in the time direction h₁₁, h₁₂ are separated by 7 data symbols (denoted as Δy₁₁₋₁₂, not shown).

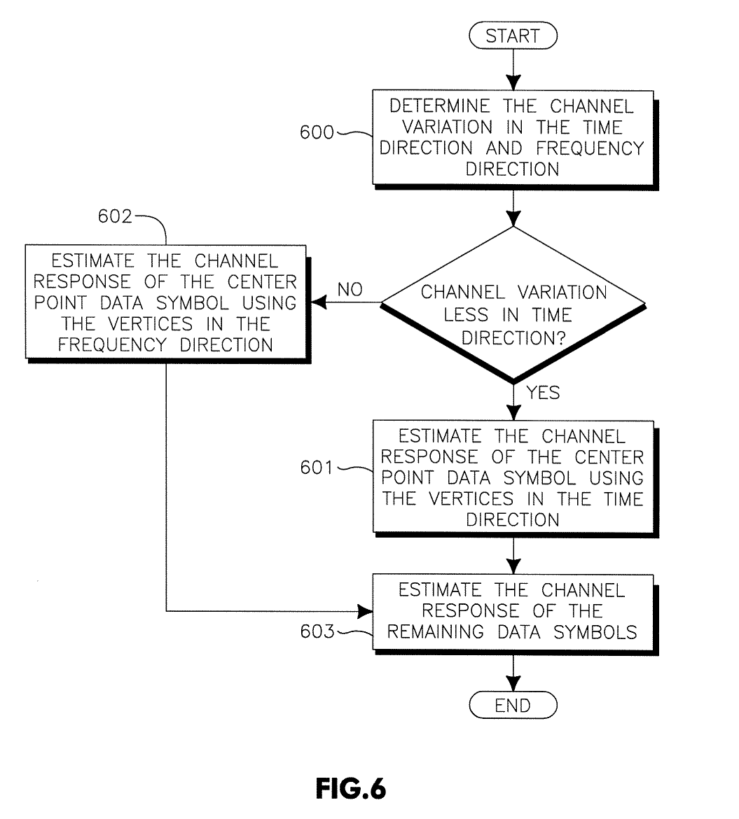

FIG. 6 is a flow diagram of the disclosed channel interpolation method. A WTRU 120 receives a downlink signal, including data symbols and reference symbols, at receiver 126. The reference symbols are scattered within a subframe of the signal. Receiver 126 forwards the received signal to processor 125, which performs the channel estimation as disclosed.

The channel values at parallelogram 300 vertices 310. are used to interpolate center point subcarrier 320 of corresponding parallelogram 300. Each parallelogram 300 is first examined in both frequency and time directions (Step 600). If channel variation is less in the time direction, interpolation is done in the time direction using h₁₁ and h₁₂ (Step 601), otherwise interpolation is done in the frequency direction using h₂₁ and h₂₂ (Step 602). The interpolation in this stage is preferably a linear interpolation. In mathematical form it may be expressed as:

$$If \frac{\vert {h}_{12} - {h}_{11} \vert}{Δ {y}_{11 - 12}} \leq \frac{\vert {h}_{22} - {h}_{21} \vert}{Δ {x}_{21 - 22}} , \\ then {h}_{c} = \frac{Δ {cp}_{11}}{Δ {y}_{11 - 12}} ( {h}_{12} - {h}_{11} ) + {h}_{11} , \\ else {h}_{c} = \frac{Δ {cp}_{21}}{Δ {x}_{11 - 12}} ( {h}_{22} - {h}_{21} ) + {h}_{21} ; \qquad ( Equation 1 )$$

where Δcp₁₁ and Δcp₂₁ are the number of subcarriers between h₁₁ and h₂₁ and the center point h_{c} in the time and frequency directions, respectively. Therefore, in accordance with the example illustrated in FIG. 3, Equation 1 is as follows:

$$If \frac{\vert {h}_{12} - {h}_{11} \vert}{7} \leq \frac{\vert {h}_{22} - {h}_{21} \vert}{6} , then {h}_{c} = \frac{4}{7} ( {h}_{12} - {h}_{11} ) + {h}_{11} , \\ else {h}_{c} = \frac{3}{6} ( {h}_{22} - {h}_{21} ) + {h}_{21} .$$

Those having skill in the art will recognize that the relationship between time and frequency must be known or determined in order to compare the channel variation in the frequency direction and the channel variation in the time direction. As such, in the example illustrated in FIG. 4, Δf is the reciprocal of the distance between two adjacent subcarriers in the time direction, Δt, i.e., Δf=15 KHz, and Δt=66.67 μsec (=1/15 KHz.). The relationship between frequency and time, as well as the values selected for Δf and Δt, are for an example only and should be used to limit the disclosed method.

Once the center point subcarriers 320 of the parallelograms 300 are interpolated, interpolation is done for the remaining subcarriers 301 in accordance with a classic interpolation algorithm (i.e. first in frequency direction along OFDM symbols, and then in time direction across the subframe), depending on the computational complexity (Step 603). For example, in the frequency direction, Lagrange interpolation of any order, or a cubic spline can be used. In the time direction, a higher order Lagrange interpolation can be used depending on the affordable latency. However, a piecewise linear (2^{nd} order Lagrange) or 3^{rd} order Lagrange may also yield satisfactory results.

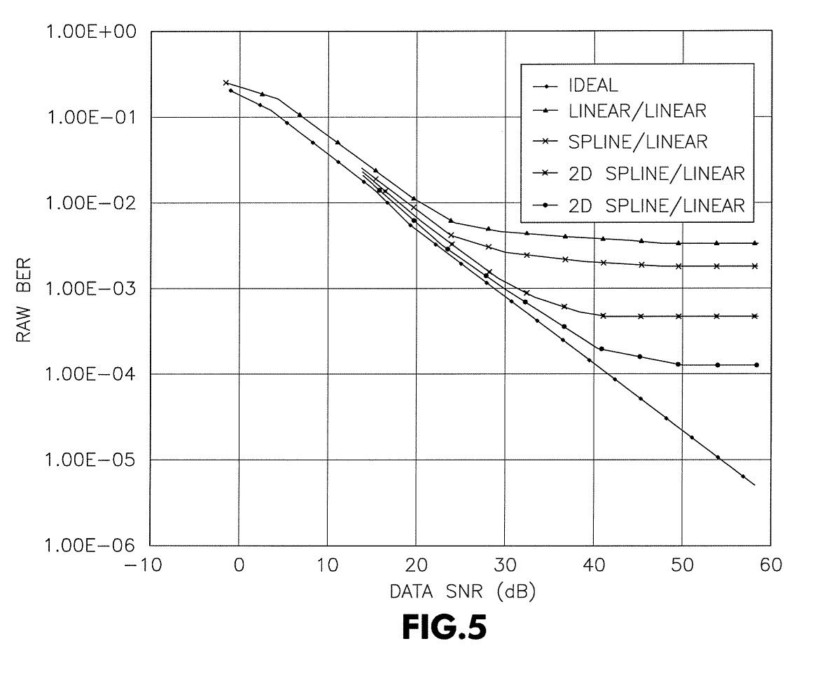

FIG. 5 shows the superior performance of the adaptive two-dimensional interpolation compared to conventional schemes. As shown, conventional schemes suffer from huge losses in high SNR manifested as a very high error floor. Whereas the proposed two-dimensional scheme with cubic spline interpolation in the frequency direction and linear interpolation in the time direction yield BER performance very close to ideal channel estimation/interpolation.

Although the features and elements are described in particular combinations, each feature or element can be used alone without the other features and elements or in various combinations with or without other features and elements. The methods or flow charts provided may be implemented in a computer program, software, or firmware tangibly embodied in a computer-readable storage medium for execution by a general purpose computer or a processor. Examples of computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine.

A processor in association with software may be used to implement a radio frequency transceiver for use in a wireless transmit receive unit (WTRU), user equipment (UE), terminal, base station, radio network controller (RNC), or any host computer. The WTRU may be used in conjunction with modules, implemented in hardware and/or software, such as a camera, a video camera module, a videophone, a speakerphone, a vibration device, a speaker, a microphone, a television transceiver, a hands free headset, a keyboard, a Bluetooth® module, a frequency modulated (FM) radio unit, a liquid crystal display (LCD) display unit, an organic light-emitting diode (OLED) display unit, a digital music player, a media player, a video game player module, an Internet browser, and/or any wireless local area network (WLAN) module.

What is claimed is:

1. A method for performing channel estimation of a received downlink signal including data symbols and reference symbols, said reference symbols scattered throughout a subframe of said signal, comprising:
dividing a time frequency representation of the subframe into parallelograms, wherein the vertices of each parallelogram are one of said reference symbols;
determining a channel variation in a time direction and in a frequency direction; and
estimating a channel response of a data symbol at the center point of said parallelogram using two of said reference symbols from opposing vertices of said parallelogram based on said determination step.

2. The method of claim 1, further comprising:
comparing the channel variation in the time direction to the channel variation in the frequency direction;
performing interpolation on the vertices in the time direction when the channel variation in the time direction is less than the channel variation in the frequency direction; and
performing interpolation on the vertices in the frequency direction when the channel variation in the frequency direction is less than the channel variation in the time direction.

3. The method of claim 2, wherein said estimation of said center point is determined using the following equation:
$${h}_{c} = \frac{Δ {cp}_{11}}{Δ {y}_{11 - 12}} ( {h}_{12} - {h}_{11} ) + {h}_{11} ;$$
where h₁₂-h₁₁ are the respective channel responses of said vertices in the time direction of said parallelogram, Δy₁₁₋₁₂ is the number of subcarriers between h₁₂ and h₁₁ in the time direction, and Δcp₁₁ is the number of subcarriers between h₁₁ and the center point h_{c} in the time direction.

4. The method of claim 2, wherein said estimation of said center point is determined using the following equation:
$${h}_{c} = \frac{Δ {cp}_{21}}{Δ {x}_{11 - 12}} ( {h}_{22} - {h}_{21} ) + {h}_{21} ;$$
where h₂₂-h₂₁ are the respective channel responses of said vertices in the frequency direction of said parallelogram, Δx₂₁₋₂₂ is the number of subcarriers between h₁₂ and h₁₁ in the frequency direction, and Δcp₂₁ is the number of subcarriers between h₂₁ and the center point h_{c} in the frequency direction.

5. The method of claim 2, further comprising estimating the channel response of the remaining data symbols.

6. A wireless transmit receive unit (WTRU) comprising:
a receiver for receiving downlink signal including data symbols and reference symbols, said reference symbols scattered throughout a subframe of said signal; and
a processor, for performing channel estimation of said received downlink signal, wherein a time frequency representation of the subframe is divided into parallelograms, the vertices of each parallelogram being one of said referenced symbols, comprising:
an estimator for estimating a channel response of a data symbol at the center point of said parallelogram using two of said reference symbols from opposing vertices of said parallelogram based on a determination of a channel variation in a time direction and a frequency direction.

7. The WTRU of claim 6, wherein said processor performs interpolation on the vertices in the time direction when the channel variation in the time direction is less than the channel variation in the frequency direction.

8. The WTRU of claim 7, wherein said estimator estimates said center point in accordance with the following equation:
$${h}_{c} = \frac{Δ {cp}_{21}}{Δ {x}_{11 - 12}} ( {h}_{22} - {h}_{21} ) + {h}_{21} ;$$
where h₂₂-h₂₁ are the respective channel responses of said vertices in the frequency direction of said parallelogram, Δx₂₁₋₂₂ is the number of subcarriers between h₁₂ and h₁₁ in the frequency direction, and Δcp₂₁ is the number of subcarriers between h₂₁ and the center point h_{c} in the frequency direction.

9. The WTRU of claim 8, wherein said estimator estimates the channel response of the remaining data symbols.

10. The WTRU of claim 6, wherein said processor performs interpolation on the vertices in the frequency direction when the channel variation in the frequency direction is less than the channel variation in the time direction.

11. The WTRU of claim 10, wherein said estimator estimates said center point in accordance with the following equation:
$${h}_{c} = \frac{Δ {cp}_{11}}{Δ {y}_{11 - 12}} ( {h}_{12} - {h}_{11} ) + {h}_{11} ;$$
where h₁₂-h₁₁ are the respective channel responses of said vertices in the time direction of said parallelogram, Δy₁₁₋₁₂ is the number of subcarriers between h₁₂ and h₁₁ in the time direction, and Δcp₁₁ is the number of subcarriers between h₁₁ and the center point h_{c} in the time direction.

12. The WTRU of claim 11, wherein said estimator estimates the channel response of the remaining data symbols.
